(19) United States
(12) Patent Application Publication
(10) Pub. No.: US 2006/0038144 A1
(43) Pub. Date: Feb. 23, 2006

(54) Method and apparatus for providing optimal images of a microscope specimen

(76) Inventor: John R. Maddison, Nottingham (GB)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/924,343

(22) Filed: Aug. 23, 2004

(51) Int. Cl. G01V 8/00

(52) U.S. Cl. 250/559.05; 250/559.06

(57) ABSTRACT

A method for providing image data for an optimal image of a microscope field of view of a specimen is described. The method uses a microscopy digital imaging apparatus to capture a plurality of digital images of a specimen contained within a microscope field of view at a corresponding plurality of microscope focusing positions. The plurality of digital images are processed to obtain data representing a single optimal image of the microscope field of view which is stored in memory. The optimal image combines or utilizes the image information from the plurality of images, and is particularly useful for specimens that have a depth of view or thickness.

### BACKGROUND OF THE INVENTION

1. Field of the Invention

The present invention relates to the acquisition and processing of digital microscope images and, more particularly, to a method for providing digital images of microscope specimens having a depth of view (also referred to herein as “thickness”), so that the images provide an optimised representation of the specimen in order to maximise, or at least increase, the quantity of information conveyed to a viewer of the image.

2. Description of the Related Art

It is well known to capture digital images of microscope specimens for storage and viewing by, for example, a remotely located pathologist, by “Telemicroscopy” or for other purposes. Such images are typically acquired using a microscopy scanning apparatus. FIG. 1 shows a typical apparatus for scanning a microscope slide to obtain images of a specimen thereon. The apparatus comprises an optical microscope with a computer controlled, movable stage, and a digital camera to capture field of view images from the microscope and to send them to a computer for processing. The stage may be moved in stepwise fashion, and each field of view image captured by the digital camera, in order to acquire adjacent, field of view images, which may be mosaiced together to form a composite image of a larger part of the specimen on the microscope slide.

One of the problems associated with capturing biological images is the need to accurately focus the objective lens of the microscope. Thus, the apparatus of FIG. 1 is equipped with a piezo electric device, controlled by a focus controller, to automate focusing. However, due to the nature of biological specimens, which have a depth of field due to a “thickness” of the specimen, a focused image may be possible in more than one optical plane (i.e. in more than one focusing position). In GB-A-2 385 481, in the name of the present applicant, it is proposed to capture field of view images in each of a plurality of optical planes, in cases in which a plurality of focused images of the particular specimen (or parts thereof) can be acquired. This provides additional image information for assessment by a pathologist, in cases where the images are used for manual assessment. However, the review of such images is somewhat clumsy for the pathologist, since it is necessary to separately review the images at different “levels” within specimen.

In addition, for certain types of such “thick” biological specimens, such as cytology specimens, the objects or features (e.g. cells) may be sparse, and yet form clumps in which the features (e.g. cells) overlap. Thus, images taken in a single focal plane may not capture images of a large number of cells within a cytology specimen, thus limiting the value of such images.

It would be desirable to provide an improved technique for providing microscope images of specimens having a “thickness”, such as cytology specimens, which maximises, or at least increases, the amount of information provided to the user whilst presenting the images in a form that makes the images easy to review, for example in a conventional “Telemicroscopy” context.

### SUMMARY OF THE INVENTION

In accordance with a first aspect, the present invention provides a method for providing image data for an optimal image of a microscope field of view of a specimen, the specimen having a depth of view or thickness, the method comprising: using a microscopy digital imaging apparatus, capturing a plurality of digital images of the specimen contained within a microscope field of view at a corresponding plurality of microscope focusing positions; digitally processing the plurality of digital images to obtain data representing an optimal image of the microscope field of view, and storing the optimal image for the field of view.

Preferably said optimal image contains a higher quantity of image information relative to any one of said plurality of digital images. In a preferred embodiment the step of digitally processing comprises combining or otherwise utilizing the digital image information from at least two of said plurality of digital images to obtain the optimal image.

The step of digitally processing may include: overlaying at least two of said plurality of digital images; merging at least two of said plurality of digital images; 3D rendering of two or more of said plurality of digital images, or creating a highest contrast image by selecting, from two or more of said plurality of digital images, those pixels having the highest variance in intensity.

In accordance with a second aspect, the present invention provides a method for scanning a microscope specimen, or a part thereof, using a microscopy digital imaging apparatus comprising a microscope having a movable stage and a digital camera, the microscopy digital imaging apparatus capturing microscope field of view images of a specimen having a depth of view or thickness, the method comprising:

(a) advancing the microscope stage to a microscope field of view imaging position;

(b) capturing a plurality of digital images of the specimen contained within the microscope field of view at a corresponding plurality of microscope focusing positions;

(c) digitally processing the plurality of digital images to obtain data representing an optimal image of the microscope field of view;

(d) storing the optimal image data for the field of view, and

(e) repeating steps (a) to (d) for further microscope field of view imaging positions to obtain optimal field of view image data for the complete specimen or part thereof.

Preferably, the further field of view imaging positions are substantially adjacent, field of view images on a predetermined scanning path, and the method further comprises digitally processing the optimal field of view image data, for example by mosaicing the field of view images, to provide a composite image of the complete specimen or part thereof.

In accordance with a third aspect, the present invention provides a computer readable medium containing program instructions that, when executed, carry out the method of the first or the second aspect of the present invention.

Other preferred features and advantages of the present invention will be apparent from the following description and accompanying claims.

### BRIEF DESCRIPTION OF THE DRAWINGS

Embodiments of the present invention will now be described, with reference to the accompanying drawings, in which:

FIG. 1 shows an apparatus for acquiring and processing digital microscope images, which may be utilised in accordance with an embodiment of the present invention;

FIG. 2 is a schematic cross section of a typical microscope slide containing a cytology specimen;

FIG. 3 is a flow diagram illustrating a method for acquiring and processing specimen images to provide optimal images in accordance with an embodiment of the present invention;

FIG. 4 is an image of microscope specimen acquired using conventional techniques, and

FIG. 5 is an optimal image of the microscope specimen provided using a method in accordance with an embodiment of the present invention.

### DETAILED DESCRIPTION OF THE PREFERRED EMBODIMENTS

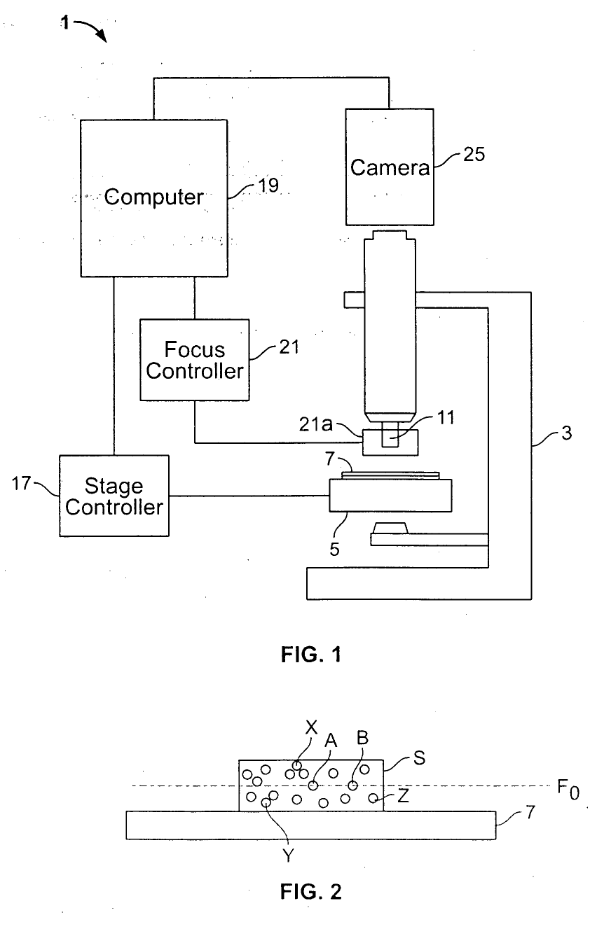

FIG. 1 illustrates a typical apparatus 1 for acquiring and processing digital, microscope images, that may be used to carry out a method according to a preferred embodiment of the present invention. The apparatus 1 comprises an optical microscope 3 having at least one objective lens 11, and a movable microscope stage 5, on which is placed a microscope slide 7 containing a biological specimen S (not shown). The microscope stage 5 is driven by a stage controller 17 under the control of a computer 19, in a predetermined path to acquire adjacent, field of view images in accordance with conventional “Telemicroscopy” image acquisition techniques. A preferred conventional technique for image acquisition for Telemicroscopy is described in EP-A-0 994 433 entitled “Microscopy” in the name of the present applicant, the disclosure of which is hereby incorporated by reference. It will be appreciated by the skilled person, however, that for some applications, the field of view images captured in accordance with the present invention do not need to be adjacent images, but could simply be selected parts or predetermined arbitrary positions on the slide or specimen. However, for applications where a composite image of the specimen is required, it is preferable to capture adjacent field of view images that can be readily “mosaiced” together.

The microscope 3 is equipped with a piezo electric device 21a, which is controlled by a focus controller 21, also under the control of computer 19, to focus the objective lens 11 of the microscope 3 in different optical planes for capturing images at different focal depths. A digital camera 25 is attached to the microscope 3, optically coupled to the objective lens 11, to capture digital images of the specimen S on the slide 7. The digital camera 25 is coupled to computer 19, which synchronises image capture with the movements of the stage 5 and the focusing of the microscope 3. Digital camera 25 sends the captured images to the computer 19 for digital processing and storage, as described below. The above described image acquisition of microscope images is commonly referred to as “scanning”, and this term will be used below.

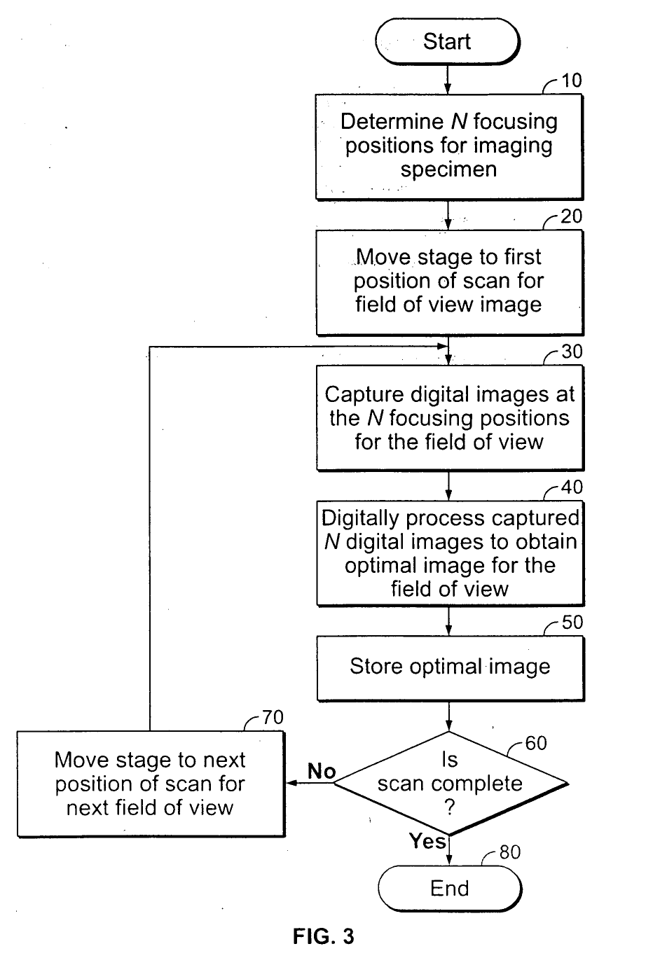

Computer 19 thus not only includes scanning/control software to control the microscope stage 5, focus controller 21 and digital camera 25, but also image processing software that, in a preferred embodiment, also performs a method for providing optimal field of view images of microscope specimens having a depth of view or “thickness”. In particular, the optimal images provide a best or optimal representation of the specimen in the field of view of the microscope in order to maximise, or at least increase, the image information provided to a viewer of the image, as described below with reference to FIG. 3.

FIG. 2 shows a schematic cross section of a typical cytology specimen S comprising clumps of cells and sparsely distributed cells in a liquid based medium. As illustrated in FIG. 2, the cytology specimen has a “thickness”, typically 30 microns. Thus, images taken in a single optical or focus plane, such as the central plane F₀in FIG. 2, which has a depth of view of only about 1-2 microns, will capture clear, focused images of some cells such as A and B, but will not capture clearly focused images for cells such as cells X, Y and Z, which are situated near the top or bottom of the specimen S. Thus, images taken in a single optical or focus plane (i.e. at a single focusing position) do not accurately represent the complete specimen, and consequently images of vital features (e.g. cells) within the specimen S may not be captured for consideration by a viewer such as a pathologist.

Accordingly, in addressing this problem, the present invention creates a single “optimal” image of a specimen having a “thickness”, such as a cytology specimen, which contains increased image information in comparison with conventional techniques by using image information (data) from a plurality of field of view images of the same part of the specimen taken in different focusing positions.

The method of one, preferred embodiment of the present invention will be described below with reference to FIG. 3. Typically, the method is implemented in the form of a computer program that is part of the aforementioned image acquisition (scanning) and processing software, the latter of which may “mosaic” together adjacent field of view images. However, it will be appreciated that the program may be separate from other scanning and image processing software. The computer program is typically provided on a computer readable medium such as a magnetic or optical disc, or in other form for loading on to a computer 19 (for instance it may be downloaded from a website over the Internet, and thus be embodied on a carrier wave). The method may also be performed in hardware.

As shown in FIG. 3, the method, starts at step 10 by initially determining the number N and focal depth of a plurality of N focusing positions to be used for the specimen. This may be predetermined for a certain type of specimen, which may be manually changed by a user. N may be between 3 and 20, and is preferably about 5 (for speed of image acquisition). Preferably, however, the method is fully automated, and the N focussing positions are determined for the particular specimen using historical data to optimise the technique.

At step 20, the method moves the microscope stage 5 of the microscope of FIG. 1, to a first position for “scanning” the specimen S on slide 7 in accordance with conventional techniques (this is typically the top left or bottom right corner of the specimen area on the slide 7). The stage 5 is then stopped at this position, and at step 30, a plurality of N images of the specimen S contained within the field of view of the microscope 9 are captured using digital camera 25 at the N focussing positions determined at step 10. The focus controller 21 operates in conjunction with the camera 25 and under the control of the computer 19 to synchronise image capture at the predetermined N focusing positions. The N field of view images are sent by digital camera 25 to the computer and may be temporarily or permanently stored in memory for image processing as described below.

At step 40, the method digitally processes the N digital images acquired in step 30 to obtain image data representing an optimal image of the current microscope field of view. A person skilled in the art of image processing will be familiar with techniques for combining the image information from a plurality of images in order to obtain such an optimal image. For example, techniques include: overlaying at least two of said N images; merging at least two of said N digital images; 3D rendering of two or more of said N images; and selecting, from two or more of said N digital images, those pixels having the highest variance in intensity relative to the mean intensity of pixels within the image to create a highest contrast image from the two or more images. Any one or more of these techniques may be employed in step 40.

In a preferred embodiment, the method uses the “highest intensity variance pixel” technique. In particular, step 40 determines, for each image, the mean intensity of pixels and the intensity variance of each pixel within the image. The technique then compares two or more of the N field of view images on a pixel-by-pixel basis and selects, in each case, the pixel with the highest intensity variance for inclusion in an “optimal” field of view image, in accordance with the present invention. A person skilled in the art of image processing will be familiar with the mathematical algorithms for determining the highest intensity variance pixel, which corresponds to the best focus or highest contrast for a feature within an image.

Thus, step 40 creates an “optimal” image, which combines the best-focussed features of the plurality of N field of view images. The result is effectively a “flattened” image of the N separate field of view images, which maximises the quantity of image information conveyed to the viewer by representing a best focus of all of the features at different depths within the specimen.

At step 50, the method stores the optimal field of view image determined at step 40.

At step 60, the method considers whether the scan is complete. If the scan is complete, the program ends at step 80, and the optimal field of view images stored at step 50 may be processed further (e.g. by mosaicing in accordance with conventional techniques, as described below). If, on the other hand, step 60 determines that the scan is not complete, the method continues at step 70 by moving the stage 5 to the next position of the scan (e.g. for acquiring an adjacent field of view image) in accordance with conventional techniques. The program then repeats steps 30 to 70 for this and subsequent scanning positions, to obtain corresponding optimal field of view images until the scan is complete, and the program ends at step 80.

As will be appreciated from the above, the method of the embodiment of the present invention of FIG. 3 combines conventional image acquisition techniques (“scanning software”) with the creation of an optimal specimen image in accordance with the present invention. Thus, it will be appreciated that certain steps of the method illustrated in FIG. 3, such as steps 20, 60 and 70 are not essential to the present invention, but may be provided by a conventional computer program, interacting with a computer program implementing the method of the present invention.

As mentioned above, after step 80 of the program of FIG. 3, the optimal field of view images provided and stored by computer 19 may be further processed to obtain data for a composite optimal image of the specimen. In particular, the data for the optimal images stored in step 50 of FIG. 3 may be retrieved from memory and digitally processed using conventional “mosaicing” techniques to provide data for a composite optimal image of the complete specimen, or a part of the specimen larger than the field of view, which is then stored in memory.

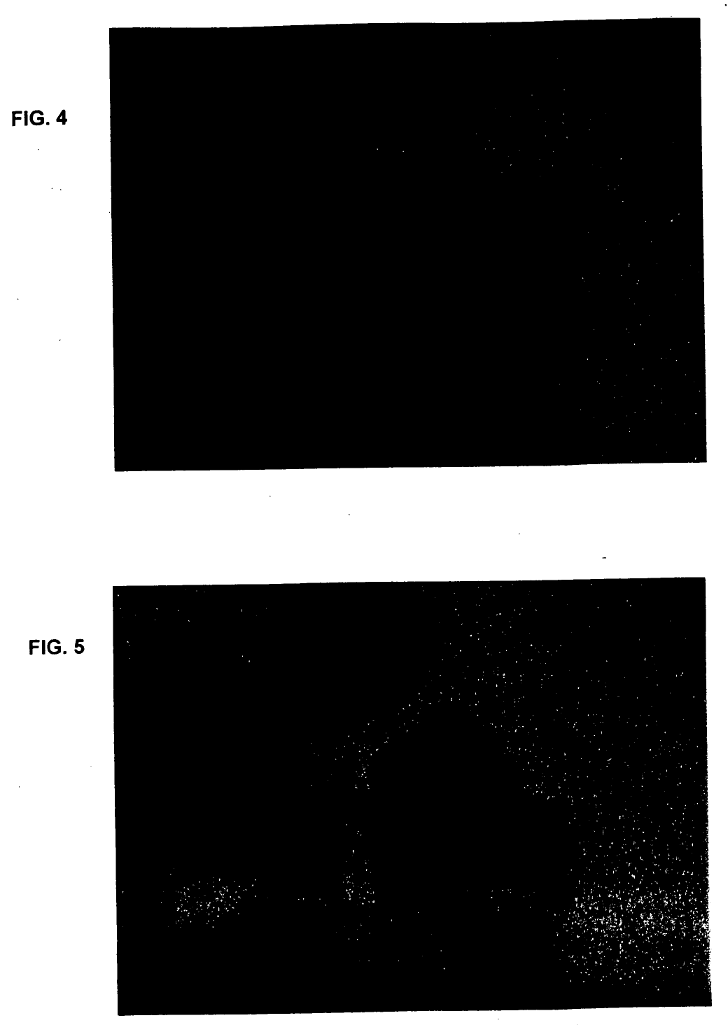

FIG. 4 illustrates a digital image of a typical microscope specimen following the mosaicing of field of view images acquired at a single focusing position in accordance with conventional techniques. Due to the depth/thickness of the biological specimen, the image of FIG. 4 shows several features of the specimen clearly and in focus, whilst a number of other features are indistinct and out of focus.

FIG. 5 illustrates an optimal image of the microscope specimen of FIG. 4, resulting from mosaicing optimal field of view images provided by digitally processing five digital images at different focusing potions in accordance with the above described “highest intensity variance pixel” technique of implementing step 40 of the method of FIG. 3. In this image, substantially all of the features of the specimen are sharp and in focus. Thus an optimal, two-dimensional composite image of the specimen is provided to the viewer.

An optimal, high magnification composite image may be provided, using a relatively high power objective lens to acquire the field of view images, for use in a telemicroscopy method such as that described in EP-A-0 944 433. If required, optimal composite images may also be obtained at other magnifications. A remote viewer can simply select portions of the high magnification image for viewing from a low magnification “navigation map” of the complete specimen, and the viewer is provided with a single, optimised image of the selected portion.

Whilst the present invention has been described in relation to the imaging of biological microscope specimens, in particular, cytology specimens, the method may be useful for other types of specimen where the specimen is transparent and has a “thickness”.

Furthermore, whilst the method of the preferred embodiment of the present invention has been described in relation to the apparatus of FIG. 1, any other suitable apparatus may be used.

Various modifications and changes may be made to the described embodiments. It is intended to include all variations, modifications and equivalents which fall within the spirit and scope of the present invention.

1. A method for providing image data for an optimal image of a microscope field of view of a specimen, the specimen having a depth of view or thickness, the method comprising:
using a microscopy digital imaging apparatus, capturing a plurality of digital images of the specimen contained within a microscope field of view at a corresponding plurality of microscope focusing positions;
digitally processing the plurality of digital images to obtain data representing an optimal image of the microscope field of view, and
storing the optimal image for the field of view.

2. A method as claimed in claim 1, wherein said optimal image contains a higher quantity of image information relative to any one of said plurality of digital images.

3. A method as claimed in claim 1, wherein the plurality of focusing positions is predetermined.

4. A method as claimed in claim 1, wherein the number of focusing positions is in the range of 3 and 20.

5. A method as claimed in claim 1, wherein said step of digitally processing utilises the digital image information contained within at least two of said plurality of digital images.

6. A method as claimed in claim 5, wherein the step of digitally processing comprises: overlaying at least two of said plurality of digital images; merging at least two of said plurality of digital images; 3D rendering of two or more of said plurality of digital images; creating a highest contrast image by selecting, from two or more of said plurality of digital images, those pixels having the highest variance in intensity, or any combination thereof.

7. A method for scanning a microscope specimen, or a part thereof, using a microscopy digital imaging apparatus comprising a microscope having a movable stage and a digital camera, the microscopy digital imaging apparatus capturing microscope field of view images of a specimen having a depth of view or thickness, the method comprising:
(a) advancing the microscope stage to a microscope field of view imaging position;
(b) capturing a plurality of digital images of the specimen contained within the microscope field of view at a corresponding plurality of microscope focusing positions;
(c) digitally processing the plurality of digital images to obtain data representing an optimal image of the microscope field of view;
(d) storing the optimal image data for the field of view, and
(e) repeating steps (a) to (d) for further microscope field of view imaging positions to obtain optimal field of view image data for the complete specimen or part thereof.

8. A method as claimed in claim 7, wherein the further field of view imaging positions are substantially adjacent, field of view images on a predetermined scanning path.

9. A method as claimed in claim 8, further comprising:
(f) digitally processing the optimal field of view image data to provide a composite image of the complete specimen or part thereof.

10. A method as claimed in claim 9, wherein the step (f) of digitally processing comprises mosaicing the field of view images.

11. A computer readable medium containing program instructions that, when executed, carry out the method of claim 1.

12. A computer readable medium containing program instructions that, when executed, carry out the method of claim 7.

13. A method for telemicroscopy comprising:
scanning a microscope specimen, or a part thereof, using a method as claimed in claim 7;
digitally processing the optimal field of view image data to provide data for a composite image of the complete specimen, or part thereof, and storing the composite image data in data storage;
providing access to the data storage from a remote terminal;
transferring selected optimal image data to the remote terminal in response to requests by a user of the remote terminal.
